(19) United States
(12) Patent Application Publication
(10) Pub. No.: US 2008/0277608 A1
(43) Pub. Date: Nov. 13, 2008

(54) Method for operation of an actuating drive

(75) Inventors: Frank MARKS, Dusseldorf (DE); Wolfgang SCHOLZ, Minden (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/081,936

(22) Filed: Apr. 23, 2008

(30) Foreign Application Priority Data
Apr. 23, 2007 (DE) 10 2007 019 059.1

(51) Int. Cl. F16K 31/02

(52) U.S. Cl. 251/129.01

(57) ABSTRACT

An exemplary method is disclosed for operation of an actuating drive for control of an actuating element, which has an associated position detection device for detection of an actual position of the actuating element, which detection device is operatively connected to a regulator unit for comparison of the actual position with a predeterminable set position and for production of an actuating signal for driving the actuating drive, with the position detection device having a stationary optical scanning device whose optical axis is directed at an endless pattern which can be scanned optically and has associated numerical equivalents. The method includes: while setting up the actuating drive, moving the actuating element to a first limit position, and associating an instantaneous pattern at a focus of a scanning device with an actual position of the first limit position; moving the actuating element to a second limit position, and associating the instantaneous pattern at the focus of the scanning device with an actual position of the second limit position; and comparing numerical equivalents of the instantaneous patterns identified at the first and second limit positions with one another

### RELATED APPLICATION

This application claims priority under 35 U.S.C. §119 to German Patent Application No. 10 2007 019 059.1 filed in Germany on Apr. 23, 2007, the entire content of which is hereby incorporated by reference in its entirety.

### TECHNICAL FIELD

A method for operation of an actuating drive is disclosed for control of actuating elements for automation in process installations.

### BACKGROUND INFORMATION

Known actuating drives are equipped with a control device which compares the instantaneous actual position of the actuating element with a predetermined set position and drives the actuating drive such that the actual position is changed in a compensating form in the direction of the predetermined set position. For this purpose, the actuating drive has a position sensor arrangement, which signals the instantaneous actual position of the actuating element to the control device.

DE 42 39 635 A1 discloses a method for detecting the position of the valve rod movement of electropneumatic position regulators, in which an RF oscillation is excited within an LC resonance circuit in an inductively operating sensor in order to produce a radio-frequency electromagnetic alternating field, which is attenuated as a function of position by an electrically conductive body which is also moved by the valve rod, and in which the oscillator signal is demodulated and is supplied, without amplification, to a microcomputer for evaluation of the position-dependent oscillation amplitude attenuation. Although this method allows non-contacting position measurement, the hardware complexity for carrying out the method can be quite high, and the measurement accuracy can be inadequate, in particular in the event of vibration during rough installation operation.

Furthermore, DE 42 39 635 A1 has already disclosed as prior art the use of potentiometers, capacitive sensors and differential transformers, which are operated via a lever tap on the valve rod, for measuring the position of valve rods. These already known solutions can have many disadvantages. For example, potentiometers are generally subject to wear, particularly when they are used in an area of severe mechanical vibration or shaking. This wear is evident in increasing wear at the operating point of the potentiometer. The use of rotary capacitors can be very expensive since, in this case, complex protective measures can be taken against moisture and, furthermore, very precise mechanical bearings are used. The use of differential transformers can be disadvantageous because of the expensive mechanical bearing, since lateral accelerations of the magnet are suppressed in the coil. The electronics which are correspondingly used for supply purposes can also be expensive and have a relatively high power consumption. Furthermore, care should to be taken to ensure correct installation of the sensors, whose rotation angles are limited.

DE 100 16 636 A1 discloses a position regulator, in particular for a valve which can be operated by a drive, having a position transmitter for detection of the actual position of an actuating element, and having a regulator unit for comparison of the actual position with a predeterminable set position and for production of an actuating signal, in which a magnet and a magneto resistive sensor are provided as the position transmitter and can be rotated or moved relative to one another, corresponding to a movement of an actuating element.

### SUMMARY

A method is disclosed for operation of an actuating drive for control of an actuating element, which has an associated position detection device for detection of an actual position of the actuating element, which detection device is operatively connected to a regulator unit for comparison of the actual position with a predeterminable set position and for production of an actuating signal for driving the actuating drive, with the position detection device having a stationary optical scanning device whose optical axis is directed at an endless pattern which can be scanned optically and has associated numerical equivalents, the method comprising: while setting up the actuating drive, moving the actuating element to a first limit position, and associating an instantaneous pattern at a focus of a scanning device with an actual position of the first limit position; moving the actuating element to a second limit position, and associating the instantaneous pattern at the focus of the scanning device with an actual position of the second limit position; and comparing numerical equivalents of the instantaneous patterns identified at the first and second limit positions with one another.

### BRIEF DESCRIPTION OF THE DRAWINGS

The disclosure will be explained in more detail in the following text with reference to exemplary embodiments. In the drawings:

FIG. 1 shows an outline illustration of an exemplary actuating drive, which is operated by a pressure medium, having a process valve;

FIG. 2 shows an outline illustration of an exemplary position detection device having a pattern support in the form of a disk; and

FIG. 3 shows an outline illustration of an exemplary position detection device having a pattern support in the form of a roller.

### DETAILED DESCRIPTION

A method for operation of an actuating drive is disclosed, which is tolerant to human operating errors.

The disclosure is based on an actuating drive for control of an actuating element, which has an associated position detection device for detection of the actual position of the actuating element, which device is operatively connected to a regulating unit for comparison of the actual position with a predeterminable set position and for production of an actuating signal for driving the actuating drive. The position detection device has a stationary optical scanning device whose optical axis is directed at an endless pattern which can be scanned optically, is arranged on a pattern support and is associated with the numerical equivalent.

When the position of the actuating element changes, the pattern support can be readjusted appropriately. The pattern change at the focus of the scanning device can be identified as a change in the actual position of the actuating element.

While setting up the actuating drive, the actuating element is moved to a first limit position, and the instantaneous pattern at the focus of the scanning device is associated with the actual position of the first limit position. A movement of the actuating element is then carried out to a second (e.g., opposite) limit position, and the instantaneous pattern at the focus of the scanning device is associated with the actual position of the second limit position.

The determined numerical equivalents of the identified patterns at the limit positions are compared with one another. The difference between the numerical equivalents at the limit positions is the movement range of the actuating element between the limit positions. In the case of a rotary actuating element, the movement range can be the rotation angle, and in the case of a linear actuating element, the movement range can be the limit movement. In this case, the movement range of the actuating element is independent of the pattern sequence on the pattern support. The absolute position of the pattern support and of the pattern imaged on it is independent of the limit positions and the movement range of the actuating element. An exemplary method disclosed herein can be advantageously resistive to incorrect position-related installation of the pattern support. The pattern support can accordingly be installed as required in terms of its position at the focus of the scanning device.

According to a further exemplary feature, the instantaneous pattern at the focus of the scanning device can be recorded (e.g., at any or all positions), and can, for example, be associated with an actual intermediate position, at at least one intermediate position (e.g., at a midpoint or at any other suitable location) between the limit positions in the movement range of the actuating element. The direction in which the numerical equivalents have changed, (e.g., rising or falling values), can be determined from the comparison of the numerical equivalents of the identified patterns at the limit positions and at the at least one intermediate position.

An exemplary method according to the disclosure is advantageously not only resistive to incorrect position-related installation of the pattern support, but also to laterally offset installation of the pattern support.

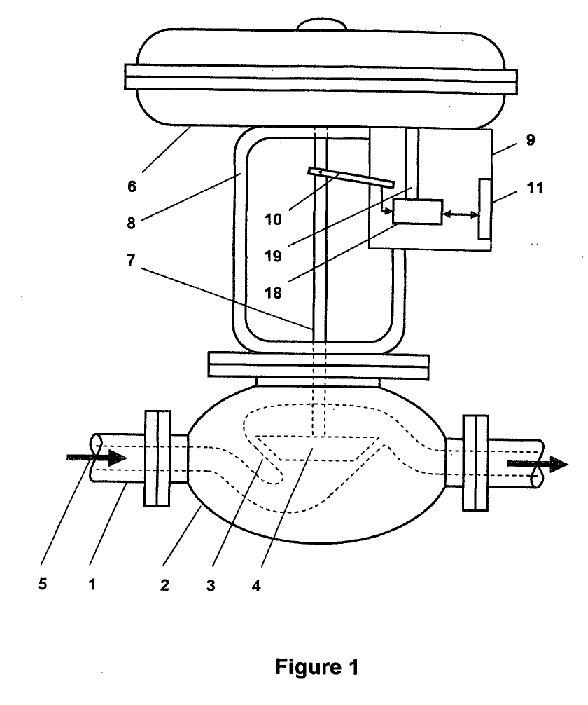

FIG. 1 shows an exemplary embodiment with a pipeline 1 which is indicated in a fragmentary form, of a process installation, which is not illustrated in any more detail, in which a process valve 2 is installed. In its interior, the process valve 2 has a closure body 4, which interacts with a valve seat 3, for controlling the flow rate of the process medium 5. The closure body 4 is operated linearly by an actuating drive 6 via a valve rod 7. The actuating drive 6 is connected to the process valve 2 via a yoke 8. A position regulator 9 is fitted to the yoke 8. The movement of the valve rod 7 is signaled to the position regulator 9 via a position sensor 10. The detected movement is compared in a control unit 18 with the set value supplied by a communication interface 11, and the actuating drive 6 is driven as a function of the determined control error. The control unit 18 for the position regulator 9 has an I/P converter for conversion of an electrical control error to an adequate control pressure. The I/P converter of the control unit 18 is connected to the actuating drive 6 via a pressure medium supply 19.

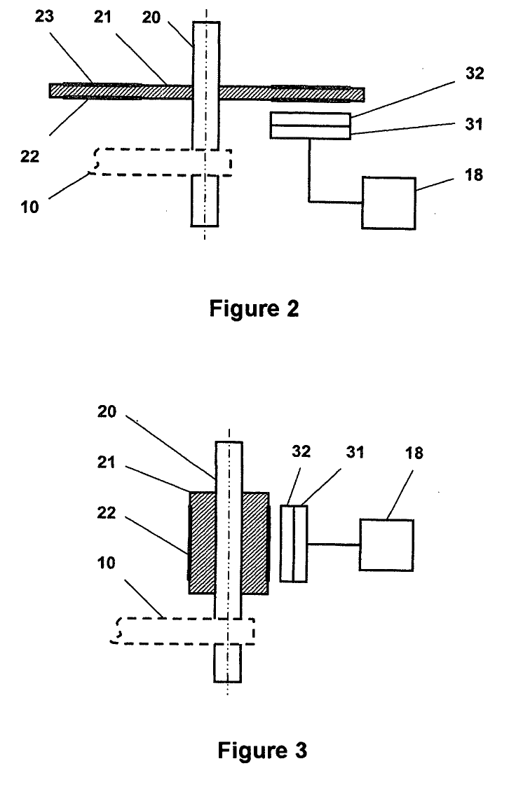

FIG. 2 shows a partially sectioned illustration of an exemplary position detection device which is mounted on a shaft 20, which is rotated by the position sensor 10 as a function of the movement of the valve rod 7, by rotationally symmetrical pattern support 21 which is in the form of a disk, and can be rotated via the shaft 20. The surface of the pattern support 21 is covered radially by an endless pattern 22 which can be scanned optically. In detail, a 16-bit Gray code is applied in a concentric annular shape to the pattern support 21.

The position detection device also has a scanning device, whose focus is directed at the pattern 22. The scanning device can essentially comprise a sensor 31 on whose optical axis, which is directed at the pattern 22, a lens 32 is arranged. The sensor 31 is connected to the control unit 18. A CCD row can be provided for the sensor 31.

The respective code at the focus of the sensor 31 is read in order to determine the instantaneous position of the valve rod 7. The pattern support 21 is appropriately readjusted whenever the position of the valve rod 7 changes. The code change at the focus of the scanning device is identified as a change in the actual position of the valve rod 7. In this case, lo there is a fixed relationship between the position sensor 10 and the codes in the movement range of the valve rod 7. If the intended relationship between the position sensor 10 and the codes in the movement range of the valve rod 7 changes as a result of a handling error during fitting of the pattern support 21, then the actual codes no longer match the expected codes in the movement range of the valve rod 7.

According to an exemplary method of the disclosure, while setting up the actuating drive, a limit position of the valve rod 7 is first of all moved to, and the instantaneous code at the focus of the scanning device is associated with the actual position of a first limit position. For this purpose, the code at the focus is read independently of its numerical equivalent, with respect to the relative association with the position of the position sensor 10. This contrasts with absolute association of the valve rod 7 at its limit positions with the position of the position sensor 10.

In a further step, a second (e.g., opposite) limit position of the valve rod 7 is moved to, and the instantaneous code at the focus of the scanning device is associated with the actual position of the second limit position. At this limit position as well, there is an absolute association between the valve rod 7 at its limit position and the position of the position sensor 10, and there is a relative association between the code and its numerical equivalent with the position of the position sensor 10.

The difference between the numerical equivalents of the identified codes at the limit positions is the movement range of the valve rod 7 between the limit positions. In the case of a rotary actuating element, the movement range can be the rotation angle, and in the case of a linear actuating element as shown in FIG. 1, the movement range can be the linear movement. In this case, the movement range of the actuating element is independent of the sequence of the codes on the pattern support 21. The absolute position of the pattern support 21 and of the codes imaged on it is independent of the limit positions and the movement range of the actuating element.

If the pattern support 21 is in the form of a disk, it is possible for the pattern 22, 23 which is in the form of concentrically circumferential annular tracks to be coincident on both sides of the disk. One of the tracks can always be at the focus of the scanning device, and the instantaneous position of the valve rod 7 can therefore be detected, irrespective of the installation orientation.

Using the same reference symbols for the same means but in a partially sectioned illustration, FIG. 3 shows an exemplary position detection device in which a rotationally symmetrical pattern support 21 in the form of a roller is mounted on a shaft 20, which is rotated by the position sensor 10 as a function of the movement of the valve rod 7, and is mounted via the shaft 20 such that it can rotate. The casing of the pattern support 21 is covered in places by a pattern 22 which can be scanned optically. In detail, a 16-bit Gray code is applied in the form of a tire to the pattern support 21.

The pattern support 21 has an associated scanning device, essentially comprising a sensor 31 and a lens 32, such that the pattern 22 is at the focus of the sensor 31. The sensor 31 is connected to the control unit 18. A CCD row may be provided for the sensor 31.

The respective code at the focus of the sensor 31 is read in order to determine the instantaneous position of the valve rod 7. The pattern support 21 is appropriately readjusted whenever the position of the valve rod 7 changes. The code change at the focus of the scanning device is identified as a change in the actual position of the valve rod 7. In this case there is a fixed relationship between the position sensor 10 and the codes in the movement range of the valve rod 7. If the intended relationship between the position sensor 10 and the codes in the movement range of the valve rod 7 changes as a result of a handling error during fitting of the pattern support 21, then the actual codes no longer match the expected codes in the movement range of the valve rod 7.

According to an exemplary method of the disclosure, while setting up the actuating drive, a limit position of the valve rod 7 is moved to, and the instantaneous code at the focus of the scanning device is associated with the actual position of the first limit position. For this purpose, the relative association between the code at the focus and the position of the position sensor 10 is read, independently of its numerical equivalent. This contrasts with absolute association of the valve rod 7 at its limit position with respect to the position of the position sensor 10.

In a further step, a second (e.g., opposite) limit position of the valve rod 7 is moved to, and the instantaneous code at the focus of the scanning device is associated with the actual position of the second limit position. In this limit position, there is also an absolute association between the valve rod 7 at its limit position and the position of the position sensor 10, and a relative association between the code and its numerical equivalent with the position of the position sensor 10.

The difference between the numerical equivalents of the identified codes at the limit positions is the movement range of the valve rod 7 between the limit positions. In the case of a rotating actuating element, the movement range can be the rotation angle, and in the case of a linear actuating element as shown in FIG. 1, the movement range can be the linear movement. In this case, the movement range of the actuating element is independent of the sequence of the codes on the pattern support 21. The absolute position of the pattern support 21 and of the codes imaged on it is independent of the limit positions and the movement range of the actuating element.

A further exemplary step provides for the instantaneous code (e.g., at any or all positions) at the focus of the scanning device to be recorded, and to be, for example, associated with an actual intermediate position, at at least one intermediate position between the limit positions in the movement range of the valve rod 7. The direction in which the numerical equivalents are changing is determined from the comparison of the numerical equivalents of the identified patterns at the limit positions and the at least one intermediate position.

In this way, in addition to angular position errors of the pattern support 21, the consequences of such position errors, which change the sequence of the applied codes, can also be eliminated.

The pattern support 21 for a rotary drive may be arranged directly on the rotation axis of the rotary drive.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline
2 Process valve
3 Valve seat
4 Closure body
5 Process medium
6 Actuating drive
7 Valve rod
8 Yoke
9 Position regulator
10 Position sensor
11 Communication interface
18 Control unit
19 Pressure medium supply
20 Shaft
21 Pattern support
22, 23 Patterns
30 Scanning device
31 Sensor
32 Lens

What is claimed is:

1. A method for operation of an actuating drive for control of an actuating element, which has an associated position detection device for detection of an actual position of the actuating element, which detection device is operatively connected to a regulator unit for comparison of the actual position with a predeterminable set position and for production of an actuating signal for driving the actuating drive, with the position detection device having a stationary optical scanning device whose optical axis is directed at an endless pattern which can be scanned optically and has associated numerical equivalents, the method comprising:
while setting up the actuating drive, moving the actuating element to a first limit position, and associating an instantaneous pattern at a focus of a scanning device with an actual position of the first limit position;
moving the actuating element to a second limit position, and associating the instantaneous pattern at the focus of the scanning device with an actual position of the second limit position; and
comparing numerical equivalents of the instantaneous patterns identified at the first and second limit positions with one another.

2. The method as claimed in claim 1, comprising:
determining a movement range of the actuating element from a difference between the numerical equivalents of the patterns identified at the first and second limit positions.

3. The method as claimed in claim 2, comprising:
recording the instantaneous pattern at the focus of the scanning device at at least one actual intermediate position of the actuating element; and
associating the instantaneous pattern with the actual intermediate position at the at least one intermediate position between the first and second limit positions in the movement range of the actuating element.

4. The method as claimed in claim 3, comprising:
comparing the numerical equivalents of the patterns identified at the first and second limit positions and at the at least one intermediate position; and
determining a direction in which the numerical equivalents are changing from the comparison.
